(19) United States
(12) Patent Application Publication
(10) Pub. No.: US 2011/0119728 A1
(43) Pub. Date: May 19, 2011

(54) SYSTEM AND METHOD FOR REMOTELY REPRODUCING CONTENT

(75) Inventors: Woo-Yong Chang, Yongin-si (KR); Seung-dong Yu, Osan-si (KR); Se-jun Park, Yongin-si (KR); Min-jeong Moon, Seongnam-si (KR)

(73) Assignee: Samsung Electronics Co., Ltd., Suwon-si (KR)

(21) Appl. No.: 12/943,562

(22) Filed: Nov. 10, 2010

(30) Foreign Application Priority Data
Nov. 13, 2009 (KR) 10-2009-0109442

(51) Int. Cl. H04N 7/173

(52) U.S. Cl. 725/118

(57) ABSTRACT

A system and method for remotely reproducing content wherein content to be reproduced is transmitted to an external device. If new content are obtained while the content is currently being transmitted, the transmission of the content is stopped and the new content is transmitted to the external device. Accordingly, content from a device may be reproduced in another device, and if new content is obtained, the new content may be reproduced first.

### PRIORITY

This application claims priority under 35 U.S.C. §119(a) to Korean Patent Application No. 2009-0109442, filed in the Korean Intellectual Property Office on Nov. 13, 2009, the disclosure of which is incorporated herein by reference.

### BACKGROUND OF THE INVENTION

1. Field of the Invention

The present invention relates generally to a system and a method for remotely reproducing content, and more particularly, to a system and method for reproducing, in a digital device, content stored in another digital device.

2. Description of the Related Art

Currently, electronic devices are being designed to perform a number of functions, which were previously performed by individual devices. For example, mobile communication terminals now provide camera functions, video functions, web browsing functions, etc., in addition to the conventional communication functions. However, there is still a limit on the number of functions that can reasonably be performed by a single electronic device. Therefore, a need still exists for converging the electronic devices owned by a user to create new function, which cannot be performed by a single digital device.

### SUMMARY OF THE INVENTION

Accordingly, the present invention is designed to address at least the above-described problems and/or disadvantages and to provide at least the advantages described below. An aspect of the present invention is to provide a system and a method for remotely reproducing, in a digital device, content from another digital device, on condition that newly acquired content is reproduced first.

In accordance with an aspect of the present invention, a method for transmitting content is provided. The method includes transmitting old content to an external apparatus, obtaining new content, stopping transmission of the old content, and transmitting the new content to the external apparatus.

In accordance with another aspect of the present invention, a method for reproducing content is provided. The method includes receiving old content from a first external, reproducing the old content, receiving new content from a second external apparatus, stopping reproduction of the old content from the first external apparatus, and reproducing the new content received from the second external apparatus.

### BRIEF DESCRIPTION OF THE DRAWINGS

The above and/or other aspects, features, and advantages of the present disclosure will be more apparent by describing certain embodiments of the present invention with reference to the accompanying drawings, in which:

FIG. 1 illustrates a network to which the present invention is applicable;

FIG. 2 illustrates a method for remotely reproducing content according to an embodiment of the present invention;

FIG. 3A illustrates a Graphical User Interface (GUI) for selecting a digital camera provided through a Digital TeleVision (DTV), according to an embodiment of the present invention;

FIG. 3B illustrates a GUI for selecting a DTV provided through a digital camera, according to an embodiment of the present invention;

FIG. 4 illustrates a DTV in which photographic content is displayed with a photographing date and caption, according to an embodiment of the present invention;

FIG. 5 illustrates a method for remotely reproducing content according to an embodiment of the present invention;

FIG. 6 illustrates a method for remotely reproducing content according to an embodiment of the present invention;

FIG. 7 illustrates method for remotely reproducing content according to an embodiment of the present invention;

FIG. 8 is a block diagram illustrating a digital camera included in a system for remotely reproducing content, according to an embodiment of the present invention; and

FIG. 9 is a block diagram illustrating a DTV included on a system for remotely reproducing content, according to an embodiment of the present invention.

### DETAILED DESCRIPTION OF EMBODIMENTS OF THE INVENTION

Various embodiments of the present invention are described in detail below with reference to the accompanying drawings. In the following description, like drawing reference numerals are used for the like elements, even in different drawings. Additionally, the matters defined in the description, such as detailed construction and/or elements, are provided to assist in a comprehensive understanding of the various embodiments. However, the various embodiments may be practiced without these specifically defined matters. Further, well-known functions or constructions are not described in detail, to avoid obscuring the application with unnecessary detail.

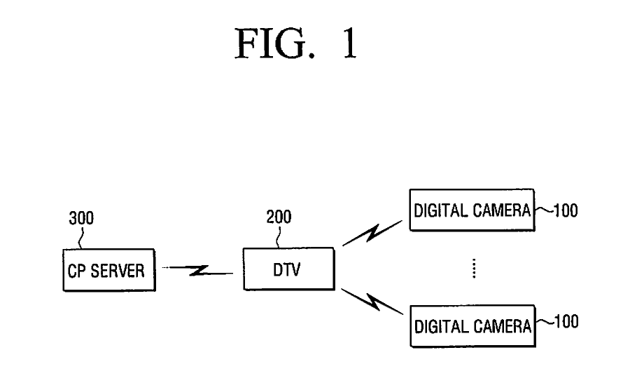

FIG. 1 illustrates a network to which the present invention is applicable.

Referring to FIG. 1, the network includes a plurality of digital cameras 100, a DTV 200, and a Content Provider (CP) server 300. The digital camera 100 generates and transmits content, and the DTV 200 receives and reproduces content.

While the digital cameras 100, the DTV 200, and the CP server 300 are connected wirelessly in FIG. 1, these components may also be connected via wire.

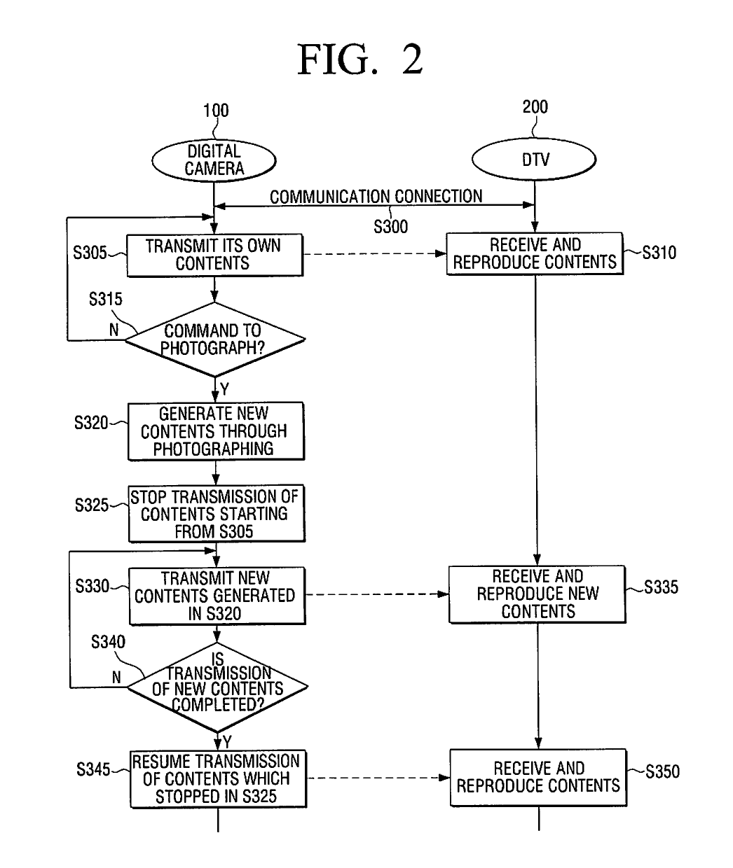

FIG. 2 illustrates a method for remotely reproducing content according to an embodiment of the present invention. Specifically, FIG. 2 illustrates operations performed by a digital camera 100 on the left thereof and operations performed by a DTV 200 on the right thereof.

Referring to FIG. 2, in step S300, the digital camera 100 and the DTV 200 establish a communication connection. In step S305, the digital camera 100 starts transmitting its content to the DTV 200. The DTV 200 receives the contents from the digital camera 100 and starts reproducing the received content in step S310.

While the content is being transmitted to the DTV 200 in step S305, the digital camera 100 may perform another function, such as photographing an image.

For example, if a user photographs an image using the digital camera 100 while content is being transmitted in step S315, the digital camera 100 generates new content through photographing in step S320, and in step S325, stops transmission of the content, which started in step S305.

In step S330, the digital camera 100 transmits the new content generated in step S320 to the DTV 200. In step S335, the DTV 200 receives the new content transmitted from the digital camera 100 and reproduces the received contents.

In step S340, if the transmission of the new content is completed, in step S350, the digital camera 100 resumes transmission of the content that was stopped in step S345.

While the method illustrated in FIG. 2 is described using a system including one digital camera 100 and one DTV 200, the method may also be applied to a system including a plurality of digital cameras 100 and a plurality of DTVs 200.

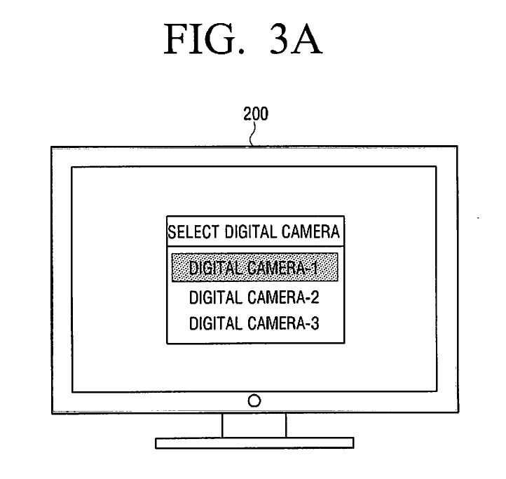

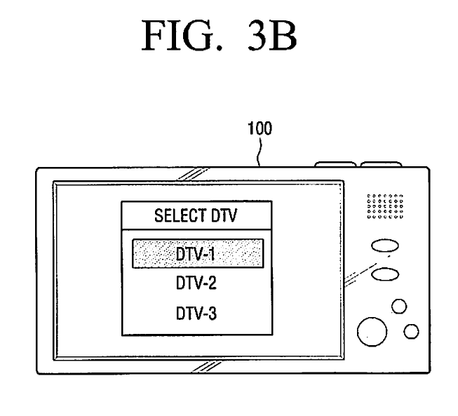

If there are a plurality of digital cameras 100, a digital camera may be selected from among the plurality of digital cameras 100 to establish a communication connection as illustrated in step S300 of FIG. 2. For example, the selection of a digital camera 100 from among a plurality of digital cameras 100 may be performed using a GUI provided by the DTV 200, as is illustrated in FIG. 3A.

Similarly, if there are a plurality of DTVs 200, one of the DTVs should be selected for establishing a communication connection illustrated in step S300 of FIG. 2. For example, the selection a DTV 200 from among the plurality of DTVs 200 may be performed using a GUI provided by the digital camera 100, as is illustrated in FIG. 3B.

As described above, a system for remotely reproducing content allows a DTV to receive content from a plurality of digital cameras and reproduce the received content. In this case, the DTV not only receives and reproduces content stored in a plurality of digital cameras, but also receives and reproduces content newly generated by the plurality of digital cameras, e.g., as they photograph new images.

If new content is received from a plurality of digital cameras, the content may be reproduced in the order that transmission of content is completed. For example, if transmission of new content-1 from a digital camera-1 is completed, the new content-1 is reproduced, and subsequently, if transmission of new content-2 from digital camera-2 is completed, then new content-2 is reproduced.

When content is being transmitted in step S305 of FIG. 2, although all content stored in the digital camera 100 may be transmitted, a user may only want to transmit part of the content. In this case, a user may select the part of the content to be transmitted using a GUI for selecting specific content.

Although the digital camera 100 described above obtains new content through photographing, photographing is merely an example of obtaining new content, and content can be obtained in a number of other ways. For example, contents may be received from other electronic apparatuses or networks, or a user may personally write content.

Content may include video, still image, audio, text, etc. Basically, there is no limit to the type of content. Accordingly, content received from other electronic apparatuses or networks may include video content, still image content, audio content, or text content.

Further, the content written by a user may also include image content, audio content, and/or text content. For example, the still image content may include content drawn by user through an application for drawing an image, the audio content may include content recorded by a user through an application for recording, and the text content may include content written by a user using a keyboard or touch screen input, for example.

While the DTV 200 reproduces the new content in step S335 of FIG. 2, additional information regarding the new content may also be provided. In this case, the digital camera 100 may be requested to provide additional information with the new content in step S330 of FIG. 2. For example, the additional information may include a generation date, a generation time, and/or a generation place of the new content.

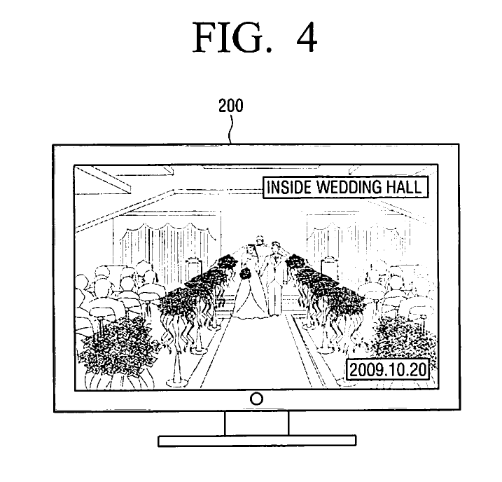

FIG. 4 illustrates the DTV 200 displaying a photograph, i.e., content, with a photographing date and location, i.e., additional information.

While the method of FIG. 2 has been described above with reference to a system including the digital camera 100 and the DTV 200, it should be apparent to a one of ordinary skill in the art that this method may also be applied to a system for remotely reproducing content includes other electronic devices.

In the above-described method illustrated in FIG. 2, if the digital camera 100 transmits content, the DTV 200 reproduces the content in the order that transmission of content is completed, giving priority to the newest content. That is, if the digital camera 100 transmits content in the order of content-1->content-2->content-3, the DTV 200 reproduces content-1, after transmission of content-1 is completed, until transmission of content-2 is completed. Once the transmission of content-2 is completed, the DTV 200 reproduces content-2, until transmission of content-3 is completed. Once the transmission of content-3 is completed, the DTV 200 reproduces content-3.

However, the DTV 200 may also reproduce received content using other methods, such as reproducing content according to a specific method set by a user. For example, if a user sets a reproduction time for content as ‘5 seconds’ and if a current reproduction time of content is less than 5 seconds, the DTV 200 will not reproduce newly received content after transmission is completed, until the 5 seconds has passed.

Specifically, when the digital camera 100 transmits content in the order of content-1->content-2->content-3, the DTV 200 will not start reproducing content-3, even though transmission of content-3 is completed, if the reproduction time of content-2 does not pass 5 seconds. Similarly, the DTV 200 will not start reproducing content-2 or content-3, although transmission of content-2 and content-3 is completed, if the reproduction time of content-1 does not pass 5 seconds.

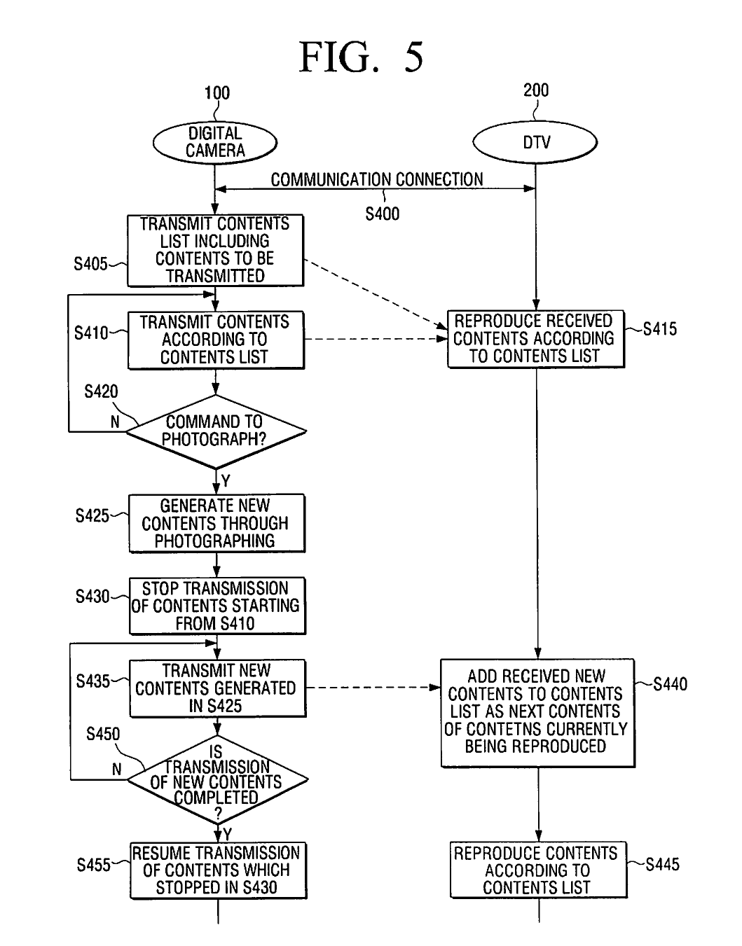

FIG. 5 illustrates a method for remotely reproducing content according to an embodiment of the present invention. Like FIG. 2, in FIG. 5, operations performed by the digital camera 100 are illustrated on the left side thereof and operations performed by the DTV 200 are illustrated on the right side thereof.

Referring to FIG. 4, in step S400, the digital camera 100 and the DTV 200 establish a communication connection. In step S405, the digital camera 100 transmits a content list to the DTV 200. In step S410, the digital camera 100 starts transmitting content to the DTV 200 in the order specified in the content list.

In step S415, the DTV 200 reproduces the content transmitted by the digital camera 100, in the order specified in the content list transmitted by the digital camera 100.

While content is being transmitted to the DTV 200 in step S410, the digital camera 100 may perform another function, such as photographing an image.

For example, if a user photographs an image using the digital camera 100, while content is being transmitted in step S420, the digital camera 100 generates new content through photographing in step S425, and in step S430, stops transmission of the content, which started in step S410.

The digital camera 100 transmits the new content generated in step S425 to the DTV 200 in step S435. In step S440, the DTV 200 adds the new content transmitted from the digital camera 100 to the contents list, such that the new content will be reproduced after the content currently being reproduced is finished. In step S445, the DTV 200 reproduces content according to the content list.

If transmission of the new content is completed in step S450, in step S455, the digital camera 100 resumes transmission of the content that was stopped in step S430.

In accordance with another embodiment of the present invention, a plurality of digital cameras 100 are connected to a DTV 200. In this case, the DTV 200 generates a single content list by combining the content lists received from the plurality of digital cameras 100, and if new content is received from a plurality of digital cameras, the new content is then added to the combined content list, e.g., according to the receiving order.

In accordance with another embodiment of the present invention, content may be remotely reproduced by a system including a digital camera 100, a DTV 200, and a CP server 300, wherein the digital camera 100 generates and transmits content, the DTV 200 receives and reproduces content, and the CP server 300 transmits stored content.

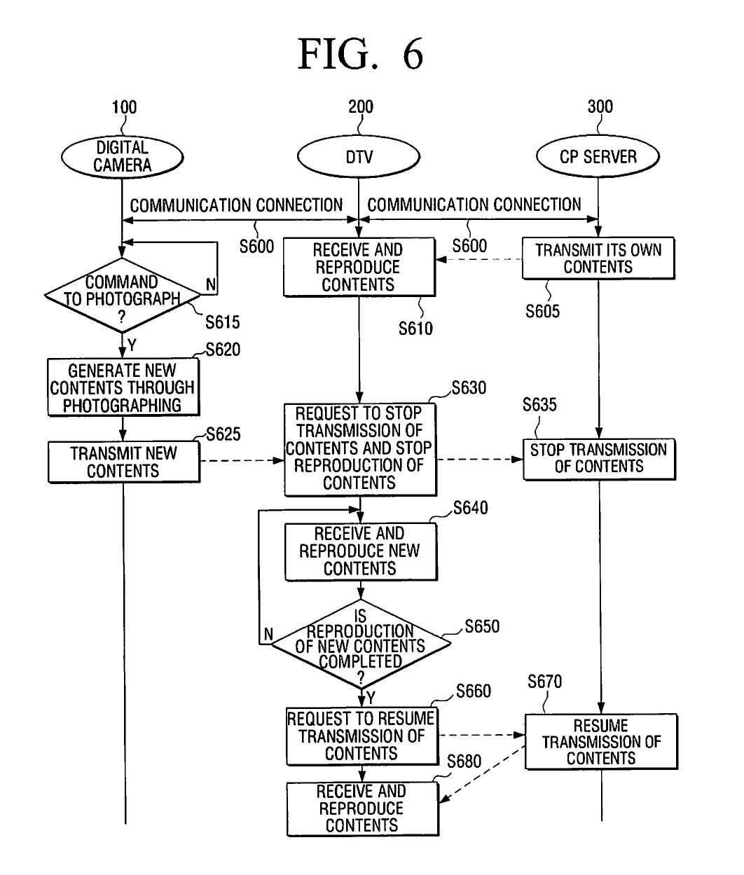

FIG. 6 illustrates a method for remotely reproducing content according to an embodiment of the present invention. In FIG. 6, operations performed by the digital camera 100 are illustrated on the left side thereof, operations performed by the DTV 200 are illustrated in the middle thereof, and operations performed by the CP server 300 are illustrated on the right side thereof.

Referring to FIG. 6, in step S600, communication connections are established between the digital camera 100 and the DTV 200, and between the CP server and the DTV 200. In step S605, as the CP server 300 starts transmitting content to the DTV 200. In step S610, the DTV 200 receives the content from the CP server 300 and starts reproducing the received content. Herein, the DTV 200 may receive content from an external apparatus such as the CP server 300 or the digital camera 100, store the received content, and reproduce the stored content. Accordingly, the DTV 200 may include a storage unit, i.e., a memory unit, which stores the received content.

While content is being transmitted to the DTV 200 by the CP server 300 in step S605, the digital camera 100 may perform another function, such as photographing an image.

For example, if a user photographs an image using the digital camera 100, while content is being transmitted in step S615, the digital camera 100 generates new content through the photographing in step S620, and transmits the new content to the DTV 200 in step S625.

In step S630, as the DTV 200 receives new contents transmitted by the digital camera 100, the DTV sends, to the CP server 300, a request to stop the transmission of the content which has been performed since step S605, and to stop reproduction of the content, which has been performed since step S610. In step S635, the CP server 300 stops transmitting the content to the DTV 200.

In step S640, after reproduction of the content is stopped in step S630, the DTV 200 reproduces the new content transmitted in step S625.

When the reproduction of the new content is completed in step S650, in step S660, the DTV 200 sends, to the CP server 300, a request to resume reproduction of the content, which was stopped in step S630. In step S670, the CP server 300 resumes transmission of the content.

In step S680, the DTV 200 receives content transmitted by the CP server 300 and resumes reproduction of the content.

Although the method illustrated in FIG. 6 is described using a system including a DTV 200, a digital camera 100, and a CP server 300, this is only an example. For example, the CP server 300 may be replaced by another digital camera 100. Accordingly, method illustrated in FIG. 6 may be applied to other electronic devices than those specifically illustrated therein.

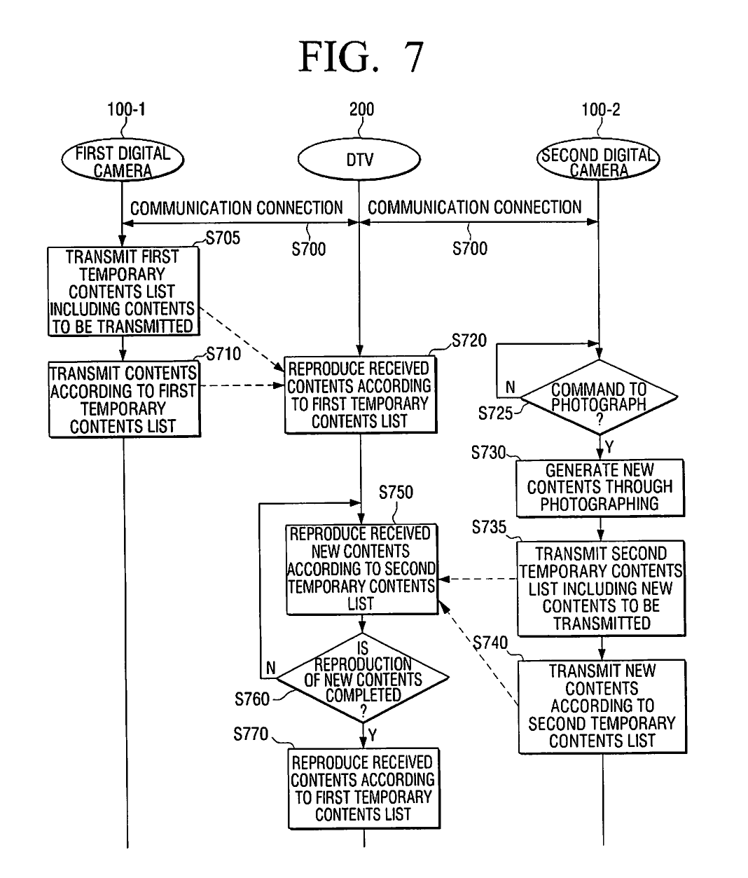

Although the method illustrated in FIG. 6, the DTV 200 reproduces the content in the order that transmission of content is completed, similarly to the method illustrated in FIG. 2, the DTV 200 may alternatively reproduce received content using other methods, such as the content being reproduced according to a method set by a user, i.e., using a content list, as described above for FIG. 5. For example, if a user sets a reproduction time for content as ‘5 seconds’, and if the reproduction time of current content is less than 5 seconds, the DTV 200 will not reproduce newly received content until after the 5 second has passed. This type of method for remotely reproducing content in the DTV 200 will be explained below in more detail with reference to FIG. 7.

FIG. 7 illustrates a method for remotely reproducing content according to an embodiment of the present invention. Specifically, the method of FIG. 7 is illustrated with reference to a system including a first digital camera 100-1, a DTV 200, and a second digital camera 100-2. The digital cameras 100-1 and 100-2 generate and transmit content, and the DTV 200 receive and reproduce content. In FIG. 7, operations performed by the digital camera 100-1 are illustrated on the left side thereof, operations performed by the DTV 200 are illustrated in the middle thereof, and operations performed by the digital camera 100-2 are illustrated on the right side thereof.

Referring to FIG. 7, in step S700, communication connections are established between the digital camera 100-1 and the DTV 200, and between the digital camera 100-2 and the DTV 200. The first digital camera 100-1 transmits a first temporary content list including a listing of content to be transmitted to the DTV 200 in step S705. In step S710, the first digital camera 100-1 starts transmitting content to the DTV 200, according to an order specified in the first temporary content.

In step S720, the DTV 200 reproduces the content transmitted by the first digital camera 100-1, according to the first temporary content list. While the content is being transmitted to the DTV 200 in step S710, the second digital camera 100-2 may perform another function, such as photographing an image.

For example, if a user photographs an image using while the content is being transmitted in step S725-Y, the second digital camera 100-2 generates new content through the photographing in step S730. In step S735, the second digital camera 100-2 transmits a second temporary content list including a listing of content to be transmitted to the DTV 200. In step S740, the second digital camera 100-2 starts transmitting the new content to the DTV 200 according to the order specified in the second temporary content list.

In step S750, the DTV 200 stops reproducing the content, which has been reproduced since step S720 and reproduces the new content transmitted by the second digital camera 100-2 in step S740. In this case, the first temporary content list and the second temporary content list may be combined with each other to generate a new content list. Alternatively, the second temporary content list may be added to the first temporary content list, or vice versa.

When the reproduction of the new content is completed in step S760-Y, in step S770, the DTV 200 resumes reproduction of the content, which was stopped in step S750, according to the first temporary content list.

Although the method in FIG. 7 is described using a system including a DTV 200 and digital cameras 101-1 and 101-2, this is only an example. For example, the digital cameras 101-1 and 101-2 may be replaced with other external apparatuses, or one of the digital cameras may be replaced by a CP server. Accordingly, method illustrated in FIG. 7 may be applied to other electronic devices than those specifically illustrated therein.

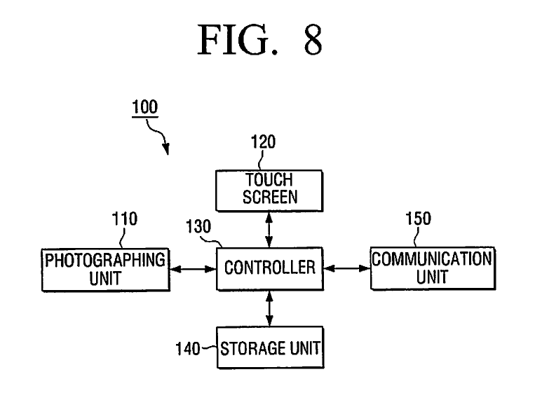

FIG. 8 is a block diagram illustrating a digital camera included in a system for remotely reproducing content, according to an embodiment of the present invention.

Referring to FIG. 8, the digital camera 100 includes a photographing unit 110, a touch screen 120, a controller 130, a storage unit 140, and a communication unit 150. When a user photographs an image, the photographing unit 110 generates content through the photographing. The content photographed by the photographing unit 110 is stored in the storage unit 140.

The touch screen 120 may be used as an input unit that receives user commands through operations such as touching or dragging, and may also be used as a display for displaying content photographed by the photographing unit 110 or content stored in the storage unit 140.

The storage unit 140, i.e., memory, provides storage space for content, and the communication unit 150 communicates with other devices, such as a DTV 200.

The controller 130 controls the photographing unit 110, the touch screen 120, the storage unit 140, and the communication unit 150 to perform the various operations of the digital camera 100, including the operations illustrated in FIG. 2, FIG. 5, FIG. 6, and FIG. 7. Accordingly, the controller 130 transmits content stored in the storage unit 140 to the DTV 200 through the communication unit 150. For example, the controller 130 may transmit a content list including content to be transmitted.

When new content is generated by the photographing unit 110, the controller 130 transmits the new content to the DTV 200 through the communication unit 150. The controller 130 may also transmit additional information regarding the new content, such as time, date, and/or location information about the new content.

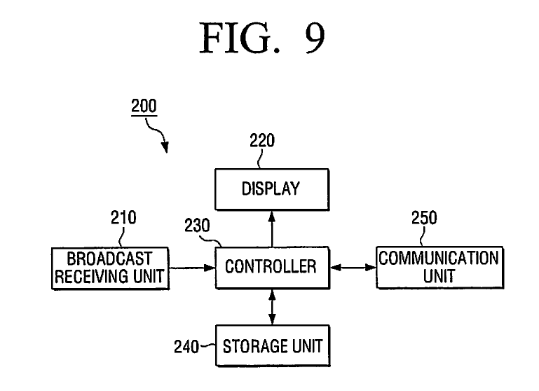

FIG. 9 is a block diagram illustrating a DTV included in a system for remotely reproducing content, according to an embodiment of the present invention.

Referring to FIG. 9, the DTV 200 includes a broadcast receiving unit 210, a display 220, a controller 230, a storage unit 240, and a communication unit 250. The broadcast receiving unit 210 performs demodulation and signal-processing on a broadcasting signal received by the DTV 200, e.g., via air or cable, converting the broadcasting signal into a reproducible form.

The display 220 displays broadcast received from the broadcast receiving unit 210 and content received from the digital camera 100.

The storage unit 240 provides storage space, i.e., memory, for storing content received from the digital camera 100. For example, the storage unit 240 may receive streaming content from the digital camera 100 and store the received content.

The communication unit 250 communicates with other devices, such as a digital camera 100.

The controller 230 controls the broadcast receiving unit 210, the display 220, the storage unit 240, and the communication unit 250 to perform various operations of the DTV 200 including the operations illustrated in FIG. 2, FIG. 5, FIG. 6, and FIG. 7. Accordingly, the controller 230 reproduces content received from the digital camera 100 through the communication unit 250 and displays the content on the display 220. Additionally, the controller 230 may store content received from the digital camera 100 through the communication unit 250 in the storage unit 240 and reproduce the stored contents according to a content list. For example, the content list may be stored in a temporary memory of the storage unit 240, such as a Random Access Memory (RAM).

If newly generated content is received from the digital camera 100 through the communication unit 250 while older content is being reproduced, the controller 230 may reproduce the newly generated content first and display the new content on the display 220.

According to the above-described embodiments of the present invention, content from a device may be reproduced in another device, and if there new content is obtained by the another device, the new content may be reproduced first. Therefore, a plurality of users may enjoy new content in real time, and if there is no new content available, existing content may be reproduced, improving user entertainment.

Although certain embodiments of the present invention have been shown and described, it would be appreciated by those skilled in the art that various changes may be made in these embodiments without departing from the principles and spirit of the present invention, the scope of which is defined in the appended claims and their equivalents.

What is claimed is:

1. A method for transmitting content for remote reproduction, comprising:
transmitting content to an external device;
obtaining new content;
stopping the transmitting of the content; and
transmitting the new content to the external device.

2. The method as claimed in claim 1, further comprising:
resuming transmission of the content that has been stopped, after the new content is completely transmitted.

3. The method as claimed in claim 1, wherein obtaining the new content comprises at least one of:
photographing an image as the new content;
receiving the new content from another external device; and
producing the new content by a user.

4. The method as claimed in claim 1, further comprising transmitting additional information regarding the new content.

5. The method as claimed in claim 4, wherein the additional information includes at least one of a generating date and a generating place of the new content.

6. The method as claimed in claim 1, wherein the new content includes at least one of a video, an image, audio, and text.

7. The method as claimed in claim 1, wherein the content includes pre-stored content.

8. The method as claimed in claim 1, further comprising:
transmitting a content list to the external device,
wherein the external apparatus uses the content list to determine a reproducing order of the content transmitted thereto.

9. The method as claimed in claim 8, wherein the new content transmitted to the external device is added to the content list by the external device.

10. The method as claimed in claim 9, wherein the new content is added to the contents list as next content to be reproduced after content currently being reproduced, or as last content on the content list.

11. A method for remotely reproducing content from external devices, comprising:
receiving content from a first external device;
reproducing the content;
receiving new content from a second external device, while reproducing the content;
stopping reproduction of the content from the first external device; and
reproducing the new content received from the second external device.

12. The method as claimed in claim 1, wherein stopping the reproduction of the content further comprises requesting the first external device to stop transmitting the content.

13. The method as claimed in claim 11, wherein receiving the content from the first external device and reproducing the content comprises:
receiving streaming content from the first external device;
storing the streaming content; and
reproducing the stored content.

14. The method as claimed in claim 11, further comprising:
receiving a contents list including a reproducing order of the content from the first external apparatus.

15. The method as claimed in claim 14, wherein the reproducing the new content received from the second external apparatus comprises adding the new content to the received content list.

16. The method as claimed in claim 15, wherein the new content is added to the contents list as a next content to be reproduced after content currently being reproduced or as last content on the content list.

17. The method as claimed in claim 11, wherein one of the first external device or the second external device is a CP server.

18. The method as claimed in claim 11, further comprising:
receiving a first temporary content list including a temporary reproducing order of the content from the first external device; and
receiving a second temporary content list including a temporary reproducing order of the new content from the second external device.
